(19) United States
(12) Patent Application Publication
(10) Pub. No.: US 2013/0054364 A1
(43) Pub. Date: Feb. 28, 2013

(54) OFFER SELECTION SYSTEM

(71) Applicant: Clifford Lyon, Melrose, MA (US)

(72) Inventor: Clifford Lyon, Melrose, MA (US)

(73) Assignee: CBS Interactive, Inc.

(21) Appl. No.: 13/221,708

(22) Filed: Aug. 30, 2011

(51) Int. Cl. G06Q 30/00

(52) U.S. Cl. 705/14.54; 705/14.49; 705/14.53

(57) ABSTRACT

A computer system for generating a message for a user has a memory configured to store a tree structure of product categories representing products presented on a web site, the tree structure having a plurality of nodes, each node representing a product category. The system is configured to select a message to be sent to the user, identify a product category for the message, determine weighting data for a plurality of the nodes based on distance of the nodes to the identified product category, select an offer from a database based at least in part on the weighting data, and generate the message using offer data associated with the selected offer.

### BACKGROUND

Some internet web sites are associated with systems that serve offers such as newsletters, e-mails, alerts and other messages to their users. Such offers comprise content which can be customized based on information the system knows about the user.

One example of such a web site is a media news site which provides product reviews and prices, software downloads, and technology news. Such a website may have a product catalog in the form of a tree structure, each level of the tree representing a different level of abstraction of products available for review on the web site. For example, one node of the tree may represent computers, with sub-nodes representing laptop computers, desktop computers, etc.

### BRIEF DESCRIPTION OF THE DRAWINGS

FIG. 1 is a schematic diagram of a tree structure, according to an exemplary embodiment.

FIG. 2 is a block diagram of a computer system for providing messages, according to an exemplary embodiment.

FIG. 3 is a flowchart of a method for providing messages, according to an exemplary embodiment.

### DETAILED DESCRIPTION OF EXEMPLARY EMBODIMENTS

One or more embodiments described herein may provide improved serving of offers to users by using a tree structure to determine similarity of products viewed by a user to the subject of an offer to the user.

One or more embodiments described herein can reduce or eliminate the need for manual updating of relatedness of new products added to a tree structure to other products in the tree structure.

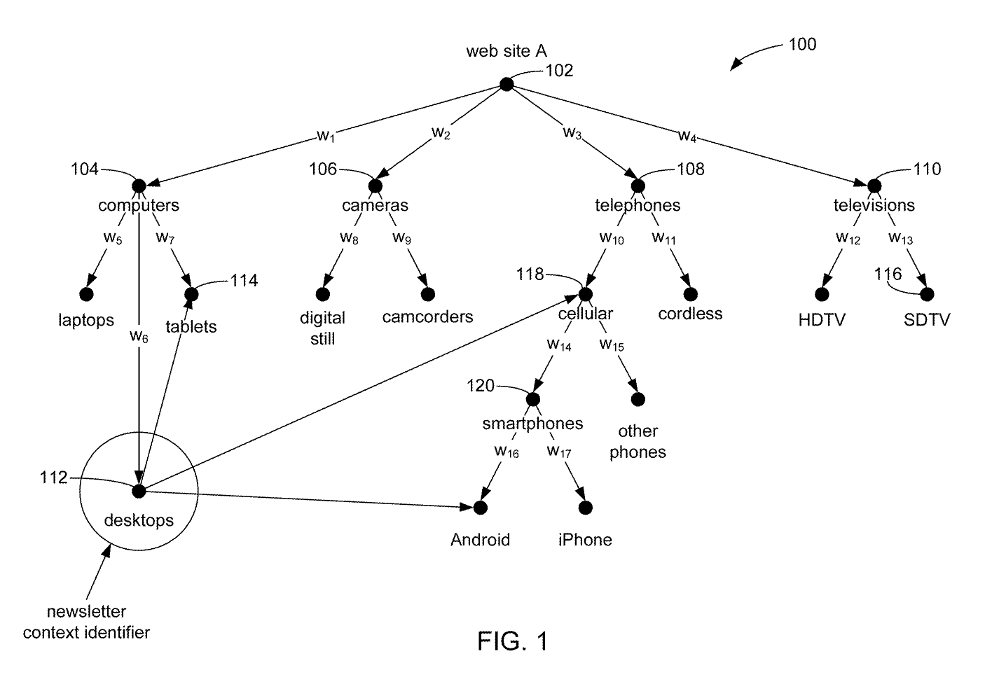

Referring first to FIG. 1, a tree structure for a web site is shown. Tree structure 100 represents a data structure stored in a memory (such as a database, file system, read only memory, etc.). Tree structure 100 may be in the form of a graph having nodes and edges between the nodes, or other hierarchy of information stored in memory. Tree structure 100 may comprise a root node 102 representing a class of products represented on a web site or portion of a web site. For example, a product information web site, such as www.cnet.com, may comprises product information, product evaluations, opinion data, user commentary, and other data relating to a plurality of different products (such as electronics products, software products, network products, or other types of products). In one example, the tree structure has 8 or 9 levels, though it may comprise more than two, more than three, more than four, less than twenty, less than ten, or other numbers of levels. In this example, node 104 represents computer products, node 106 represents camera products, node 108 represents phone products and node 110 represents television products. A node identifier may be stored in memory for each node, along with a textual description of the node, data indicating its relationship(s) to other nodes, etc. Each of nodes 104-110 may have child nodes of their own, representing product sub-categories within the product category represented by the node.

From the perspective of a given node, such as node 112 representing desktop computers, the other nodes in the tree structure have various relatedness factors relative to the given node or distances from the given node. For example, tablet computers (node 114) are more closely related to desktop computers than standard definition televisions (node 116). In one embodiment, these relatedness factors or distances can be used as weightings to personalize messages generated by a computer system on behalf of the web site directed to users. For example, a user may have subscribed to receive a particular newsletter from the web site. If a newsletter message is to be generated relating to desktops, and the newsletter message has a field which may be filled with an offer, the computer system may determine that an offer relating to tablet computers is more related to the desktop computers than an offer relating to standard definition televisions sets, and therefore insert an offer based at least on this difference in relatedness (e.g., weighting the offer selection algorithm more toward a tablet computer offer than a standard definition television set offer). Therefore, the relatedness data can be used to improve the personalization or targeting of offers. The relatedness data, which may be expressed as weighting data, may be manually entered, or automatically determined based at least in part on the number of nodes that must be traversed on the tree from the first node to the second node. Further, the connections between nodes—the “edges” in the product hierarchy graph—may each have an edge weight, which can be accumulated in a determination of the relatedness of or distance between two nodes being separated by more than one edge. This accumulation factor or data can represent a distance in subject matter terms between the two nodes, which can be used to select the offers. For example, a distance between two nodes might be considered short if both nodes are within consumer electronics sub-categories, but long at a higher level if going from electronics to household appliances, for example. The distance as used herein may mean the number of edges between two nodes in one embodiment, and in another embodiment may mean the accumulation or sum of edge weightings between the two nodes. The edge weightings may be manually entered, probabilistically determined based on users' web browsing activities or otherwise loaded from a source of such data. The edge weightings are illustrated in FIG. 1 as w₁ through w₁₃, wherein each weighting may be individually determined or configured, manually and/or based on other inputs to the system.

According to a further embodiment, a computer system may be configured to store user data indicating user interactions (e.g., what content the user has read or is reading, what the user clicked on, etc.) with each product category on the web site. For example, if a user has searched for “cellular phones” using a search algorithm configured to search content available on the web site, the user data may reflect one interaction with content associated with node 118. If a user has viewed product reviews for three different smartphones, the user data may reflect three user interactions with content associated with node 120. The computer system may further base its selection of an offer at least in part on some or all of this user data, which may be stored in the form of a user profile. For example, even though tablet computers may be more related to desktop computers than smartphones, if the user has not interacted with any tablet computer products on the web site, but the user has many interactions with smartphones (node 120), the system may be configured to select a smartphone-related offer. In a further example, the smartphone-related offer may be selected over a shoe-related offer, even if a user has had more interactions with shoe content on the web site, because of the long distance in the tree structure from shoes to desktop computers.

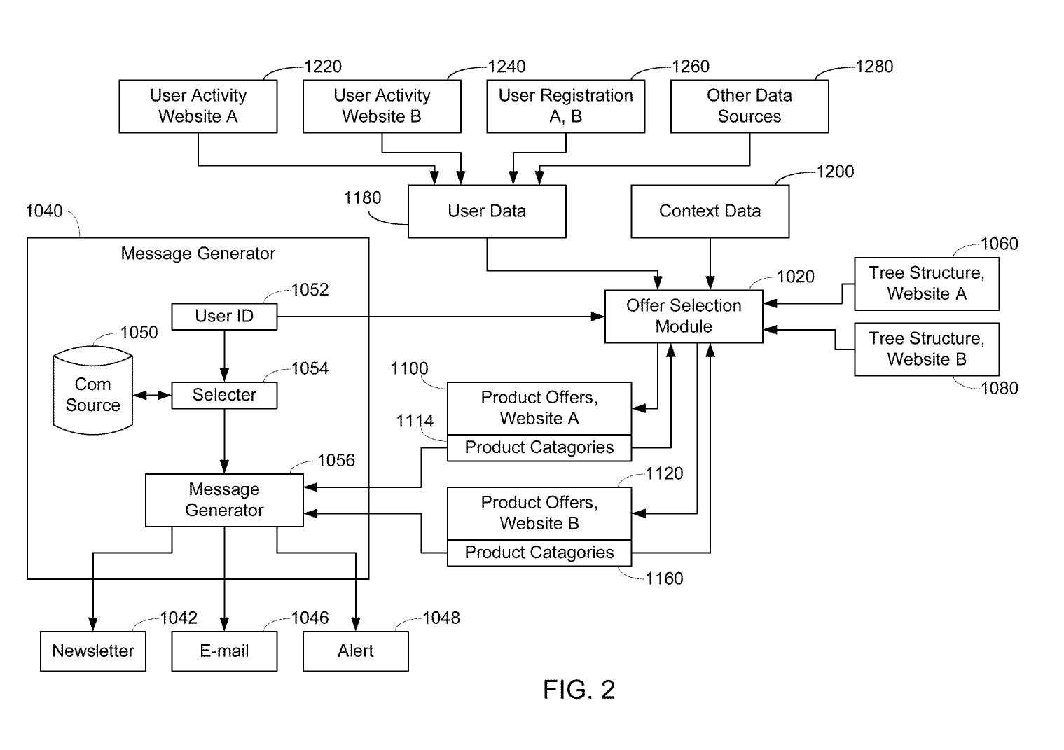

Referring now to FIG. 2, a block diagram of an offer serving platform 1000 is shown. Platform 1000 comprises an offer selection module 1020 and a message generator 1040. The offer selection module 1020 is configured to select offers to be added to messages sent to a user.

Offer selection module 1020 uses product category data structures, such as tree structures for website A 1060, website B 1080, etc., to select offers having relevance to the recipient of the message to be sent by message generator 1040. The websites may comprise product information web sites or other content-based web sites of different types (gaming content, sports content, news content, business content, etc.), such as www.cnet.com, www.bnet.com, www.cbssports.com, www.gamespot.com, etc. The offers may comprise links to product offer websites 1100, 1120, etc., which may be a price comparison website such as www.shopping.com, or other merchant websites configured to sell or link to web sites selling products. The offer data may further comprise one or more of product name, product description, offer URL, price of offer, merchant name, merchant rating, an image of the product, etc., and may be provided in XML format. The product offer websites may also have respective product category databases 114, 1160, which may comprise tree structures of their own. The tree structures of the product offer websites may have product categories the same as, or otherwise corresponding to the product offer categories of the websites 1060, 1080. For example, one or more nodes of a tree structure for website A may have corresponding nodes or product categories on a product offer website.

Offer selection module 1020 is coupled to user data source 1180 and context data source 1200. Context data source 1200 provides a product category of a message to be sent to a user. For example, if a newsletter regarding or relating to desktop computers is to be sent, context data source 1200 provides an indication of this to the offer selection module 1020, so that module 1020 may identify an offer for the message. User data source or interface 1180 is configured to receive data about a user from user activity on one or more websites 1220, 1240, etc., user registration data for one or more websites 1260, or other sources of user data 1280. For example, user data may be retrieved from a user profile database such as that described in U.S. patent application Ser. No. 13/023,377 filed Feb. 8, 2011 entitled “Targeting Offers to Users of A Website,” which is incorporated by reference herein in its entirety. As another example, user data may be retrieved from a user data store such as that described in U.S. patent application Ser. No. 13/093,658 filed Apr. 25, 2011 entitled “User Data Store,” which is incorporated by reference herein in its entirety.

Message generator 1040 is a module configured to generate the message (e.g., a newsletter 1042, an e-mail 1046, an alert 1048, etc.). Message generator 1040 is programmed to generate a message for a particular user, the user represented by a user ID 1052, by pulling message contents from a communications source 1050 using a message content selector 1054. User ID 1052 is also used in this embodiment as an input to offer selection module 1020, so that offer selection module 1020 may use features or characteristics associated with this user ID to select an offer to be inserted into the message from one or more web sites 1100, 1120. A message generator module 1056 is configured to merge, join or append the offer to the message and provide the message to a recipient address associated with the user ID.

In operation, a computer system determines that a message is to be generated, for example as part of a messaging campaign, periodic update, etc. A list of user IDs of users who have signed up for or opted-in to receipt of the message is provided to message generator 1040 at block 1052. For each user ID, offer selection module 1020 is configured to select one or more offers to accompany the message. Offer selection module 1020 receives a user ID from message generator 1040 and retrieves user data from user data source 1180. Module 1020 retrieves context data 1200 for the message (e.g., indicating the message relates to “desktop computers”). Offer selection module 1020 then retrieves from a memory the scores or weights of different nodes of tree structure 1060 based on their relatedness or proximity to a product category node indicated by context data 1200 for the message. The scores or weights may be known a priori and looked up in a distance matrix stored in a memory. Offer selection module 1020 may further score or weight different nodes of tree structure 1060 based on a quantity and/or type of user interaction with the nodes. Based on these weightings, a particular node of the tree structure 1060 is selected, and a product offer for a corresponding node in product category 1140 is selected for including with the message. Message generator 1056 incorporates the product offer into the message and sends the message in one or more formats, such as a newsletter (which may be emailed, posted, etc.), e-mail message, alert, etc.

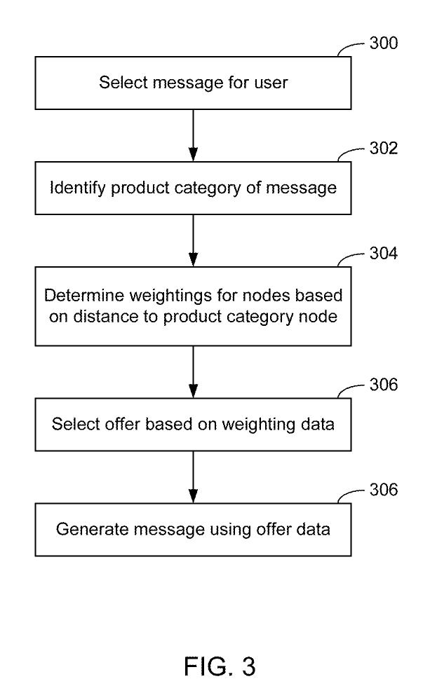

Referring now to FIG. 3, a flowchart illustrating a method of generating a message for a user will be described, according to an exemplary embodiment. A memory of the computer system is configured to store a tree structure of product categories representing products presented on a web site. The tree structure has a plurality of nodes, each node representing a product category.

At a block 300, the computer system is configured to select a message to be sent to the user. The message may be any type of offer, newsletter, promotion, etc., and may be formatted to be sent as an e-mail, text message, other electronic message, pop-up window on a web page the user is viewing, or another type of message. The message may be selected for the user based on any number of criteria, such as data from a user profile, interests stored about the user by monitoring user activity on the web page or other web pages or based on information received from the user, for example during an account registration process. In this example, the message has a product category associated with it (e.g., tablet computers, smartphones, HDTVs, etc.), wherein at least some contents of the message are related to the product category (e.g., an editorial review of a new tablet computer, etc.). At block 302, the computer system is configured to identify the product category of the message, which may comprise reading the product category in a text or numerical format from a memory location associated with the message.

At block 304, the computer system is configured to determine weighting data for a plurality of the nodes in the tree structure based on distance of the nodes to the identified product category. The determination may be made by receiving data input manually by a website operator, by looking up product category similarities from a database, by reading from a memory location weightings which have been previously calculated and/or stored, etc. Weighting data may be expressed in integer values, in fractional values, or in other values. The distance of the nodes can refer to the relatedness of the nodes. For example, a smartphone product node may have a relatedness value of 1 to a tablet PC product node; but the smartphone product node may have a relatedness value of 0.2 to a toaster oven, wherein a higher relatedness value indicates a higher relatedness of product nodes. The weighting data for the plurality of nodes may be associated with the nodes themselves relative to one another, with the edges on the tree between the nodes, and/or with other characteristics of the tree structure. In another embodiment, the tree structure itself may be defined as a collection of relatedness values or distances between a list of product categories, such that product categories having a higher relatedness value between them would be considered to be closer to each other on the tree structure (e.g., and thereby have a shorter distance between them).

At block 306, the computer system is configured to select an offer from a database based at least in part on the weighting data. The offer may have a same product category as the product category identified for the message. The computer system may be configured to weigh other factors in the selection of the offer, such as user data indicating interaction of the user on the web site with one or more of the product categories (e.g., if the user read an article or viewed a video about smartphones, the smartphone node or product category would be more highly weighted than other product categories). For example, in a case where a user has interacted with a first product category more than a second product category, the second product category may be determined to have a shorter distance to the product category of the message. In another example, if a user has used a search term that is the same as or similar to the product category (e.g., “phone” or “mobile phones” for “smartphones”), the product category may be more highly weighted in the selection of the offer for the message. At block 308, the computer system is configured to generate the message based at least in part on the offer data from the selected offer. The order of the blocks in FIG. 3 may be rearranged in alternative embodiments, and the claims are not be construed as being limited to the order of the blocks, functions or steps recited.

Further weighting of interactions can be applied, such as weighting more recent, more frequent, and/or longer lasting interactions higher than other interactions.

The offer may further be selected based on other criteria, such as a predetermined click-rate for the offer, a predetermined value of the offer, an expected payoff for the offer, or other data already obtained for the offer. Examples of other criteria that may be used to in addition to and/or alternative to those criteria discussed herein are described in For example, user data may be retrieved from a user profile database such as that described in U.S. patent application Ser. No. 13/193,417 filed Jul. 28, 2011 entitled “Clustering Offers for Click-Rate Optimization,” to Clifford Lyon, which is incorporated by reference herein in its entirety.

According to one embodiment, a plurality of different newsletters affiliated with a web site may each be associated with a respective category represented by a product node on the tree. The system may then generate distance metrics from each node to each other node and store the distance metrics as weightings indicating the relatedness of the nodes to one another. For example, if you have been shopping for or browsing a particular product, but another user used your computer to browse for a product in a completely unrelated field, the system would weight the distance between the unrelated product so low so that it would be unlikely that an offer for such a product would appear in your newsletter.

According to another embodiment, the computer system may be configured to probabilistically determine as new nodes emerge which other nodes the new nodes are related to. For example, if a new product category of tablet PCs is added to the tree, the system would be able to determine relatedness to other product nodes based on the location of the tablet PC node within the tree.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, a server computer, a cloud-based computing environment, a tablet computer, etc. Additionally, a computer may be embedded in a device not generally regarded as a computer but with suitable processing capabilities, including a Personal Digital Assistant (PDA), a smart phone or any other suitable portable or fixed electronic device.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

While specific embodiments have been disclosed, the various embodiments are not to be considered limiting. One of ordinary skill in the art will understand that variations and modifications flow from the teachings provided herein.

What is claimed is:

1. A computer system for generating a message for a user, comprising:
a memory configured to store a tree structure of product categories representing products presented on a web site, the tree structure having a plurality of nodes, each node representing a product category;
a processing circuit configured to:
select a message to be sent to the user;
identify a product category for the message;
determine weighting data for a plurality of the nodes based on distance of the nodes to the identified product category;
select an offer from a database based at least in part on the weighting data; and
generate the message using offer data associated with the selected offer.

2. The computer system of claim 1, wherein the processing circuit is further configured to:
receive user data indicating interaction of the user on the web site with one or more of the product categories; and
select the offer from the database based at least in part on the user data.

3. The computer system of claim 2, wherein the user data represents user interaction with a plurality of different websites.

4. The computer system of claim 2, wherein in a case where the user has interacted with a first product category more than a second product category, and the second product category has a shorter distance to the product category of the message, the processing circuit is configured to select an offer from the database which is in the second product category.

5. The computer system of claim 2, wherein the user data indicating interaction of the user with product categories presented on the web site comprises a search term used by the user on the web site.

6. The computer system of claim 2, wherein the user data indicating interaction of the user with product categories presented on the web site comprises an indication that the user viewed or downloaded content from the web site in at least one of the product categories.

7. The computer system of claim 1, wherein the tree structure comprises edges between the nodes and different edge weightings for each of a plurality of edges, wherein the step of determining weightings comprises accumulating at least two different weightings over a plurality of edges between a node associated with the selected product category and one of the plurality of nodes.

8. The computer system of claim 1, wherein the message comprises a newsletter message.

9. The computer system of claim 1, wherein the processing circuit is further configured to:
select a second offer from a second database based on the weighting data, wherein the first offer represents a product for sale at a first merchant web site and the second offer represents the same product for sale at a second merchant web site.

10. The computer system of claim 1, wherein the processing circuit is further configured to:
correlate a list comprising the product categories from the web site with a second list of product categories representing products for sale through a merchant web site, the merchant web site associated with the offer.

11. The computer system of claim 10, wherein the processing circuit is further configured to generate the message by inserting a hyperlink to the merchant web site in the message.

12. The computer system of claim 1, wherein the offer is further selected based on at least one of a predetermined click-rate for the offer, a predetermined value of the offer, and an expected payoff for the offer.

13. A method of generating a message for a user using a memory storing a tree structure of product categories representing products presented on a web site, the tree structure having a plurality of nodes, each node representing a product category, the method comprising:
selecting a message to be sent to the user;
identifying a product category for the message;
determining relatedness of the nodes to the identified product category;
selecting an offer from a database based at least in part on the relatedness of the nodes to the identified product category;
incorporating the selected offer into the message; and
generating the message using offer data associated with the selected offer.

14. The method of claim 13, further comprising:
receiving user data indicating interaction of the user on the web site with one or more of the product categories; and
selecting the offer from the database based at least in part on the user data.

15. The method of claim 14, wherein the tree structure comprises edges between the nodes and different edge weightings for each of a plurality of edges, wherein the determining comprises accumulating at least two different weightings over a plurality of edges between a node associated with the selected product category and one of the plurality of nodes.

16. The method of claim 15, further comprising:
correlating a list comprising the product categories from the web site with a second list of product categories representing products for sale through a merchant web site, the merchant web site associated with the offer; and
generating the message by inserting a hyperlink to the merchant web site in the message, wherein the offer is further selected based on at least one of a predetermined click-rate for the offer, a predetermined value of the offer, and an expected payoff for the offer.

17. A tangible computer-readable medium having instructions encoded thereon, wherein the instructions when processed by a processing circuit perform the following:
storing a tree structure of product categories representing products presented on a web site, the tree structure having a plurality of nodes, each node representing a product category;
selecting a message to be sent to the user;
identifying a product category for the message;
determining relatedness of the nodes to the identified product category;
selecting an offer from a database based at least in part on the relatedness of the nodes to the identified product category;
incorporating the selected offer into the message; and
generating the message using offer data associated with the selected offer.

18. The medium of claim 17, wherein the instructions when processed further comprise:
receiving user data indicating interaction of the user on the web site with one or more of the product categories; and
selecting the offer from the database based at least in part on the user data.

19. The method of claim 18, wherein the instructions when processed further comprise:
storing the tree structure comprising edges between the nodes and different edge weightings for each of a plurality of edges, wherein the determining comprises accumulating at least two different weightings over a plurality of edges between a node associated with the selected product category and one of the plurality of nodes.

20. The medium of claim 19, wherein the instructions when processed further comprise:
correlating a list comprising the product categories from the web site with a second list of product categories representing products for sale through a merchant web site, the merchant web site associated with the offer; and
generating the message by inserting a hyperlink to the merchant web site in the message, wherein the offer is further selected based on at least one of a predetermined click-rate for the offer, a predetermined value of the offer, and an expected payoff for the offer, wherein the web site comprises product review content comprising video product reviews and product ratings for a plurality of electronics products.
